(19) United States
(12) Patent Application Publication
(10) Pub. No.: US 2013/0041855 A1
(43) Pub. Date: Feb. 14, 2013

(54) Time saving method of boarding passengers onto vehicles

(71) Applicants: Donald E. Scruggs, Chino, CA (US); Pamela Lee Scruggs, Las Vegas, NV (US); Richard A Scruggs, Chicago, IL (US)

(72) Inventors: Donald E. Scruggs, Chino, CA (US); Pamela Lee Scruggs, Las Vegas, NV (US); Richard A Scruggs, Chicago, IL (US)

(21) Appl. No.: 13/136,787

(22) Filed: Aug. 10, 2011

(51) Int. Cl. G06Q 90/00

(52) U.S. Cl. 705/500

(57) ABSTRACT

A time saving method of arranging passenger waiting area seating and transport vehicle boarding and instruction to greatly reduce passenger loading time, frustration and irritation and to save fuel and engine time.

### CROSS REFERENCE TO RELATED APPLICATIONS

Not Applicable

### FEDERALLY SPONSORED RESEARCH

Not Applicable

### NAMES OF PARTIES TO JOINT RESEARCH AGREEMENT

Not Applicable

### SEQUENCE LISTING OR PROGRAM

Not Applicable

### BACKGROUND OF THE INVENTION

Currently, the first passengers on a transport vehicle, especially an airplane, usually want to sit in the first seats beyond the entry. These first passengers immediately block the aisle or aisles. The following passengers must stand waiting in an aisle, entry door or ramp while the first passengers put their bags in the overhead bins and under their seats, take off their coats and generally get comfortable. Not only is there a great deal of transport vehicle time wasted, but an amount of irritation and frustration is built up in the passengers standing and waiting for the first passengers on board to get comfortable. Once the first small group clears the aisle by sitting down, a small second group blocks the aisle while they undertake their settling-in process. This continues one group after another until the last passengers are settled.

Also current practice is to inspect the fit of carry-on items, re-seat certain passengers and give specific instructions to passengers after they are fully seated, while the transport vehicle sits idle.

### FIELD OF THE INVENTION

This invention is a time saving method to be used in waiting areas and in passenger boarding for airplanes, trains, buses, boats and other transport vehicles to save vehicle time and fuel and reduce passenger irritation and frustration. It not only saves time but is a more passenger-friendly loading method for a travel provider using it to cause passengers to select that travel provider in the future.

### RELATED ART

Currently, seats are commonly provided in transport vehicle waiting areas. Such seating is usually in rows, occasionally against walls, and or random and unorganized. Persons waiting for passage are allowed to sit on whatever seats are available and drop their coats, hats, carry-ons and other materials near where they are seated. When the transport vehicle is ready, the waiting passengers scramble to get their preferred seats, usually at the front of the vehicle. If the vehicle is loaded through the front, the passengers taking the front seats hold up all the other passengers. Some vehicles are loaded from the front and or the side and back, but a scramble usually takes place with passengers seeking seats nearest the entry, causing the rest of the passengers to wait while the first passengers through the entry get themselves settled.

### OBJECT OF THE INVENTION

It is a main object of this invention to reduce the irritation and frustration of passengers who are not first in line and must stand and wait while the first in line passengers settle themselves into the front seats of the transport vehicle.

It is another object of this invention to reduce the idle, engine running and fuel burning, waiting time of the transport vehicle itself.

It is yet another object of this invention to move the transport vehicle instructions and the qualifying of certain persons for seating at or near specific items, such as emergency exits, from the transport vehicle to the waiting area.

### SUMMARY OF THE INVENTION

Most transport vehicles sit idle, often with engines running, burning fuel, while all of the passengers find their seats and get settled. Once all passengers are settled in the transport vehicle, additional time is spent while attendants examine passengers sitting near emergency exit doors and other special places. Occasionally passengers must be moved to other seats. When all passengers are settled in appropriate seats, more time is used in giving instructions specific to the particular transport vehicle.

In the case of airplanes, the average flight time is around two and one half hours. This invention saves about fifteen minutes of time on each flight, for an approximately ten percent savings. This is especially important for engine time and fuel usage.

This invention is a method to greatly reduce the vehicle idle time during passenger assembly, loading and instruction. With this invention seats in a waiting area are arranged and numbered the same as the seats in the particular transport vehicle being used. Boxes or bins, no larger than those in the transport vehicle, are near each waiting area seat. Each box or bin represents the space available to a passenger in the transport vehicle for the storage of their carry-on bags and other articles. Passengers must put their bags in the boxes or bins and/or under their seats in the waiting area, to ensure a fit when in the transport vehicle.

Signs, such as “Front” and markings indicating special items and areas on the transport vehicle, such as “wing”, “no window”, “restroom”, etc., are placed and or marked in and around the arranged waiting area seating.

Two different indicators, preferably lights, are at each seat, controlled by waiting area personnel. One indicator shows that the seat is available for occupancy. The other indicator shows that the seat is taken by a person already in transit on the transport vehicle. Waiting area personnel can also reserve seats for special passengers in this way.

Transport vehicle operators can add request boxes to their on-line boarding pass programs where passengers can check certain preferences such as “forward seating”, “not over wing seating”, “not next to emergency exit”, “aisle seating”, “window seating” and such. This information can be transferred by computer directly to the indicators at each seat or entered by the waiting area personnel.

Before the actual transport vehicle is ready, waiting area personnel pass through the waiting area seating and check for such things as persons without a boarding pass for the current transport vehicle, persons seated in the wrong seat and persons seated in special requirement seats, such as at transport vehicle emergency exit doors. Seating adjustments are made at that time. The same waiting area personnel give instructions, such as seat belt operations, lighting and air condition control, smoking restrictions, rest room facilities, floatation device operation and other information. They also check that carry-on items properly fit in spaces provided.

When all is in order, the waiting area personnel issue a transport vehicle seat ticket or chit to each passenger having a valid boarding pass in each proper waiting area seat. The passenger's boarding pass is surrendered upon boarding the transport vehicle, while the ticket or chit is retained by the passenger as proof of seat assignment. Each passenger must sit in the transport vehicle seat according to the ticket or chit they are holding.

When a front loading transport vehicle is ready, passengers are instructed to take their carry-ons and move in order, usually rear most seats first, from the back of the seating area to the transport vehicle. The rule to follow here is that persons to be seated farthest from the entry in the transport vehicle should enter first. This method sets a column of passengers in motion with the passengers assigned to the seats farthest from the entry of the transport vehicle arriving at the farthest most seats as the passengers assigned to the closest seats arrive at their seats. All passengers are then storing their carry-on materials and getting themselves comfortable in their assigned seats during the same time period.

If the transport vehicle is to be loaded from both the front and rear, an appropriate pre-boarding waiting area seating arrangement is used. For this arrangement, a gap or cross-aisle is made between a front section of seats and a rear section of seats. Passengers designated for the front section of the transport vehicle are moved in column, rear seat passengers first, out the back of the front section of the waiting area seats, through the gap and into the front entry of the transport vehicle. Passengers designated for the rear section of the transport vehicle are moved in column, front seat passengers first, out the front of the rear section of seats in the waiting area, through the gap and into the rear entry of the transport vehicle. All passengers in the transport vehicle are then storing their carry-on materials and getting themselves comfortable in their assigned seats during the same time period.

If the transport vehicle is to be loaded from the front, the middle and the rear, an appropriate pre-boarding waiting area seating arrangement is used. For this arrangement, a gap or cross-aisle is made between a front section of seats and a middle section of seats and a second gap or cross-aisle is made between a middle section of seats and a rear section of seats. Passengers designated for the forward seats in the transport vehicle are moved in column, rearmost passengers first, out the back of the front section of waiting area seats to the front entry of the transport vehicle. Passengers designated for the middle section of seats in the transport vehicle are moved in column, rearmost passengers first, out the back of the middle section of waiting area seats to the middle entry of the transport vehicle. Passengers designated for the rear section of seats in the transport vehicle are moved in column, frontmost seats first, out the gap or cross-aisle between the middle and rear sections of waiting area seats, and into the rear entry of the transport vehicle, with passengers for the rearmost seats in the transport vehicle at the rear of the column, for all to arrive near their respective seats at the same time. All passengers are then storing their carry-on materials and getting themselves comfortable in their assigned seats during the same time period.

Passenger irritation and frustration is kept as low as possible. A line of passengers trying to board have not been made to stand and wait while a small group of passengers who were first to board adjust their carry-ons and other materials just beyond the entry of the transport vehicle, followed by a second group, who have waited for the first group, engage in their carry-on and other material adjustments, and so on down the aisle. There is only one passenger settling period for all passengers at once.

Carry-on materials have already been demonstrated in the waiting area as fitting in storage spaces, and special position seat adjustments, such as at emergency exit doors, have already been made in the waiting area seat arrangement. In addition, general instructions have been given. Everything is checked and ready to go. Waiting area personnel can have even taken drink and snack orders for delivery by transport vehicle attendants once passengers are boarded and the transport vehicle is in progress.

These seating arrangements and operating methods are examples of the invention. Any number of arrangements and variations with the benefits of the cited invention are possible. The basic principals of the invented method is that passengers determine their seating on the transport vehicle by way of sitting in waiting area seats arranged as the seats in the transport vehicle. Waiting area personnel make any necessary seating adjustments, issue a seat ticket or chit for each transport vehicle seat, give appropriate transport vehicle instructions, and finally have the passengers rise, queue up and move to and into the transport vehicle, with the passengers having the farthest seats from the transport entry door being the first to enter.

### DESCRIPTION OF THE DRAWINGS

FIG. 1 is a plan view of waiting area seats, 111, storage bins or boxes, 110, and an aisle arranged the same as in the transport vehicle, with signs, 101, marking the front of the vehicle and other special features of the vehicle, such as wings, 105, emergency exits, 104, 107, and 112, and showing the route, 102 to 108, by which the passengers, 109, will be moved to the actual transport vehicle.

FIG. 2 is a rear view of seats, 115, an optional framework, 113, on which is mounted overhead storage bins or boxes, 114.

FIG. 3 is a plan view of the actual transport vehicle showing the aisle and seating, 118, arrangement of FIG. 1 with the rearmost passengers, 116, from FIG. 1 having entered, 117, the front of the transport vehicle and proceeded, 119, to the rear of the transport vehicle, arriving at their respective seats at approximately the same time as those just entering.

FIG. 4 is another waiting area arrangement of seats, 123, aisle, signs, 121, boxes or bins, 122, special markings, 125, 126, 127, 128, and showing the passengers, 126, of the front section being moved, rearmost passengers first, out through the right side of the middle cross-aisle gap in the waiting area seats, towards the front entry of the actual transport vehicle and the passengers, 129, of the rear section, frontmost passengers first, being moved, 132, out through the left side of the middle cross-aisle gap in the waiting area seats, towards the rear entry of the actual transport vehicle.

FIG. 5 is an oblique view of a simple box or bins, 131, of three sections made to simulate the space each passenger will have for storage of carry-on materials on the transport vehicle.

FIG. 6 is a floor plan of seats and an aisle in the actual transport vehicle showing the front section passengers, 126, from FIG. 4, proceeding, 133, through the front entry of the transport vehicle and moving down the aisle until they are opposite their respective seats, and the rear section passengers, 129, from FIG. 4, proceeding, 137, through the rear entry of the transport vehicle and moving up the aisle until they are opposite their respective seats.

FIG. 7 is a layout of a waiting area arrangement of seats, 139, aisles, signs, 138, and boxes or bins, 140, with the passengers being moved in coordinated columns, with the front two groups, 142 and 145, being moved, rearmost passengers first, out through cross-aisle seat gaps, toward, 143 and 144, the actual transport vehicle and with passengers, 146, in the rearmost group being moved out, front passengers first, through a cross-aisle gap, along a line of travel, 147, to enter the rear entry of the transport vehicle, to have all passengers arrive at their assigned seating at the same time.

FIG. 8 is a plan view of the actual transport vehicle for which the seats in FIG. 7 are arranged and showing the entrances for each of the three groups in that matching of waiting area seat arrangement and transport vehicle seating, where passengers, 142, have entered the forward entry, 150, passengers, 145, have entered the middle entry, 154, and passengers, 146, have entered the rear entry, 157.

FIG. 9 is an elevation view of an arch, 166, with simulated bins and boxes, 168, over seats, 171, having under seat storage, 172, and two aisles, similar to the seat arrangement on the larger wide body jet planes.

FIG. 10 is a waiting area seat layout simulating a larger wide body jet plane having three groups of seats in three sections, with the passengers, 175, 176, 180, 181, 183 and 184, being moved out to the rear of each section and organized to enter the actual transport vehicle through a single entry toward the front of the jet plane transport vehicle.

FIG. 11 shows the seating arrangement of a larger wide body jet plane having three groups of seats in three sections, with the passengers entering through a single forward entry, 178, and moving down the two main aisles so that each passenger arrives near their respective seat at approximately the same time.

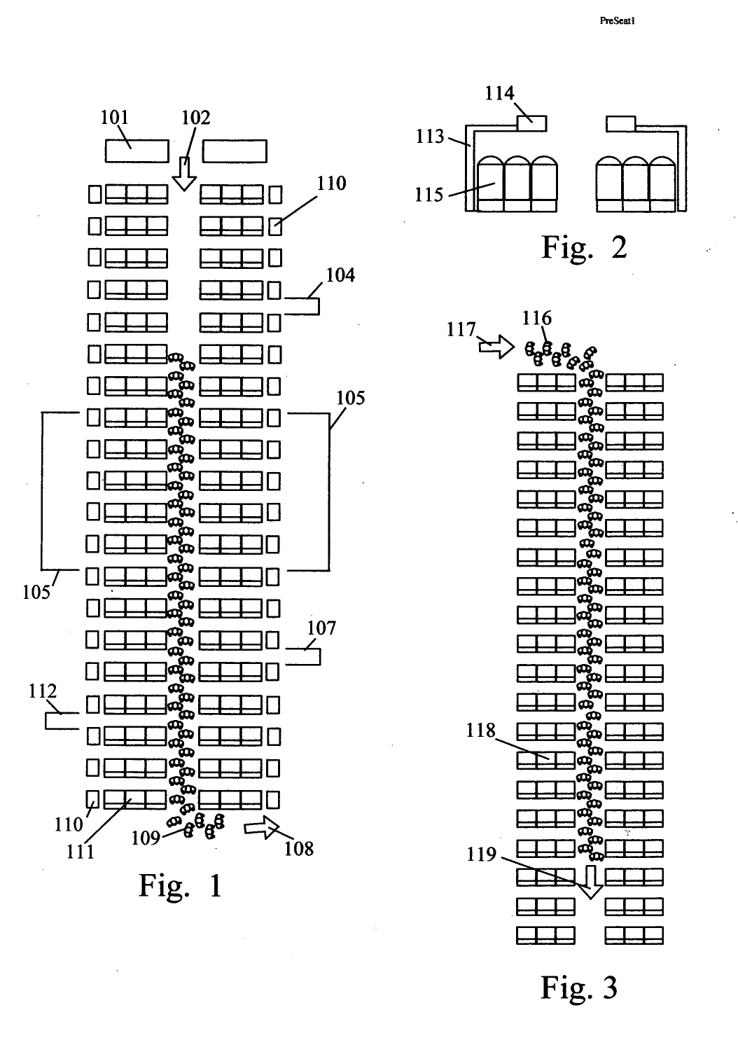

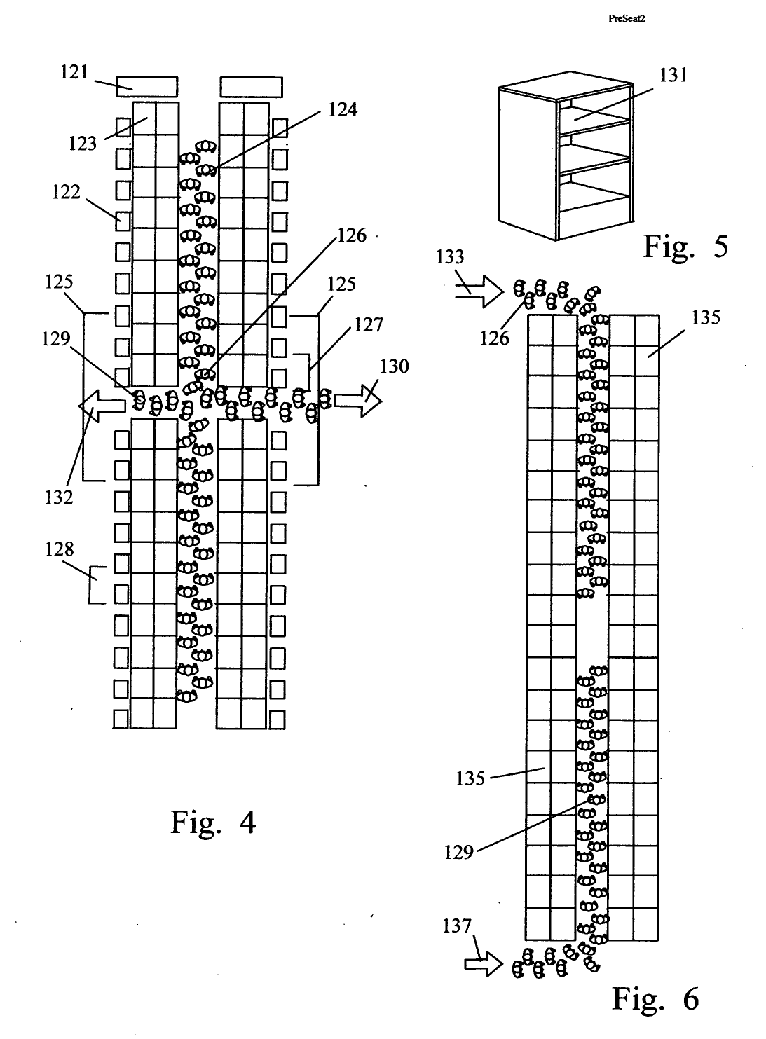

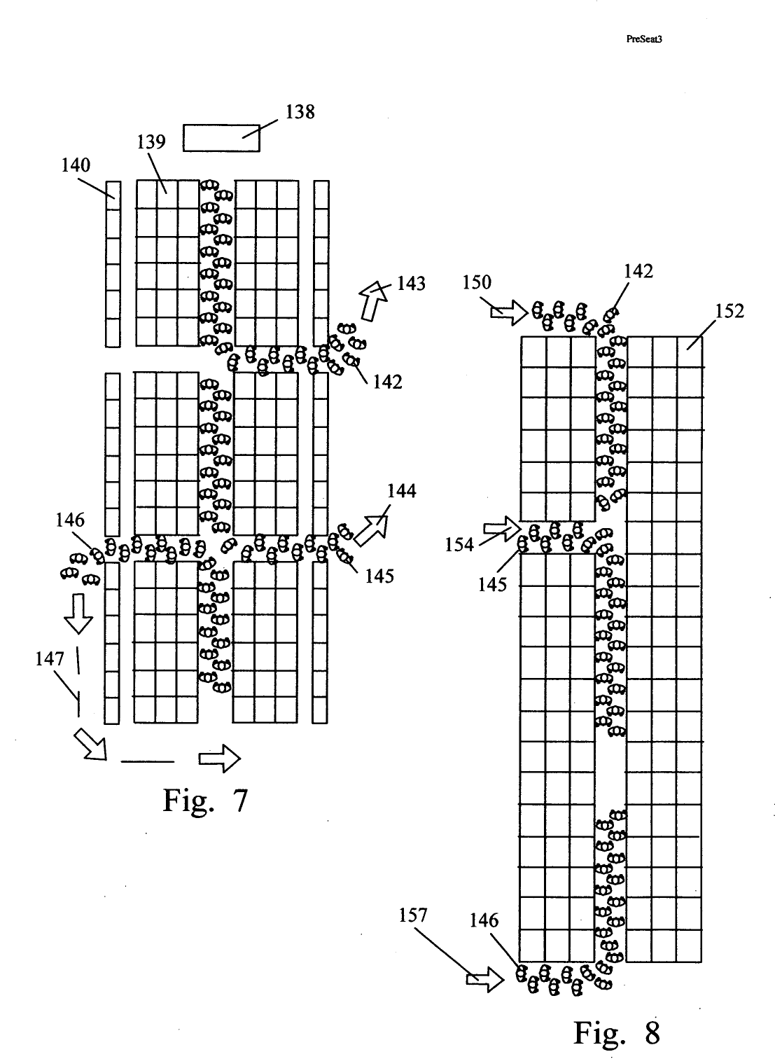

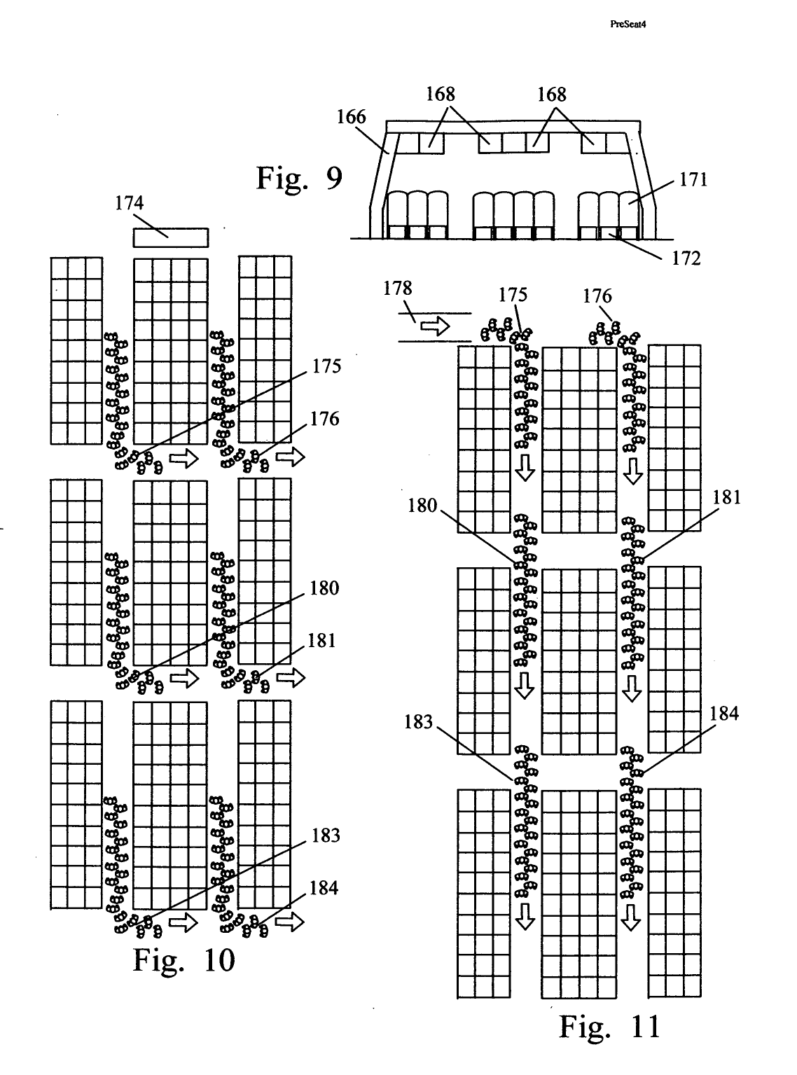

### DETAILED DESCRIPTION OF THE INVENTION

Passengers arrive at a waiting area and sit in an arranged set of seats and stow their carry-on materials in bins or boxes, observing the front of the transport vehicle by signs posted. They may have selected or indicated their preferences by internet contact. They can also select seating by way of special markings, such as location of wings on an airplane transport vehicle, blanked windows and emergency exits.

Should the waiting area personnel deem it necessary, they will request passengers to relocate out of seats adjoining the emergency exits and request other more competent appearing passengers to take these seats.

When all passengers are seated, the waiting area personnel check for proper storage of carry-on materials in the bins and or boxes, making appropriate adjustments. The waiting area personnel inspect boarding passes and issue seat assignment tickets or chits. Finally, when the transport vehicle is ready, the passengers are instructed to stand and exit in a specific order and direction, according to the transport vehicle loading plan based on this invention.

The passengers, now in seating dictated column, are moved through the appropriate exit of the waiting area and into the designated transport vehicle entry. From the entry they move down the main aisle of the transport vehicle, which places each of them very near their seat at nearly the same time.

Different waiting area seat arrangements are made to match the seat arrangement of the transport vehicle supported by the waiting area. When passengers enter the waiting area, they sit in the arranged seats, placing their carry-on materials in boxes or bins of similar size to those on the actual transport vehicle. Waiting area personnel inspect seating arrangements, carry-on storage, make any adjustments, give instructions, and finally instruct the passengers, often by specific sections, to stand and exit the waiting area in order, in a specific direction, often with farthest most passengers first in line.

The majority of arrangements of this invention have the passengers who are to be seated farthest from the transport vehicle entry the first to enter and move to the farthest set of seats in the transport vehicle. The passengers following in the rest of the column then arrive and stop with each person approximately at their assigned seat and nearby storage spaces.

Many other seating and loading arrangements are possible, such as where the transport vehicle has a main aisle, with three seats on each side of the aisle and with an entry door at the front, middle and rear of the transport vehicle. For such an example an efficient waiting area seating and passenger moving plan, based on this invention, is arranged in three groups, with three exits from the waiting area feeding passengers to specific entry doors in three locations along the side of the transport vehicle, with the first passengers to enter an entry being those seated farthest from that particular entry.

First class and business class are arranged similarly. Transport vehicles with more than one story are treated the same, with arranged waiting area seating, matching that of the actual transport vehicle. Passenger pre-assembly and boarding arrangements are much the same for the larger more complex transport vehicles, such as the wide body Boeing, Douglas, Lockheed and Airbus jets.

In summary, passengers are pre-assembled in a waiting area in seats arranged to simulate the seating arrangement in the transport vehicle on which they are to travel. Any seating adjustments are made and general and specific instructions are given in the waiting area. Passengers with boarding passes have been issued seat assignment tickets or chits and move in an orderly fashion into the transport vehicle so that each passenger arrives at the approximate location of their individual seat and storage spaces, and settles in at approximately the same time.

Time is saved because passengers to be seated farthest from the vehicle's entry door enter the vehicle first and passengers to be seated closest to the entry door enter the vehicle last and all seating adjustments and instructions have been completed in the waiting area.

I claim:

1. A method of reducing the time normally taken to board, settle and instruct passengers traveling on a transport vehicle by arranging seating in a pre-boarding waiting area to have the same seating layout and numbering as the seating on the transport vehicle on which passengers are to travel.

2. A method as in claim 1, having storage spaces near to the seating which simulate the size and shape of the carry-on material storage spaces in the transport vehicle on which passengers are to travel.

3. A method as in claim 1, with two differing and variable markers at each seat in the waiting area for indicating specific seats being reserved or available.

4. A method as in claim 1, where signs in and around a waiting area seating arrangement indicating special features of the transport vehicle on which passengers are to travel are posted relative to the positions of those features on the transport vehicle.

5. A method as in claim 1, where transport vehicle provider personnel check passenger seating near simulated emergency exit doors in a pre-boarding waiting area relative to the transport vehicle on which a passenger is to travel and move a passenger perceived to not be able to operate an emergency exit door to another seat and place a passenger perceived to be able to operate an emergency exit door in the seat near the simulated emergency exit door.

6. A method of operation where a passenger in a pre-boarding waiting area is given:
a. instruction to place his or her carry-on materials in nearby storage spaces simulating storage spaces in a transport vehicle to ensure a fit when the carry-on materials are in the transport vehicle;
b. instruction concerning the operation and use of special equipment of the transport vehicle on which they are to travel;
c. instruction concerning the general safety and safety features of the transport vehicle on which they are to travel;
d. a seat assignment ticket for a specific seat on a transport vehicle, relative to the authenticity of the passenger's boarding pass and the seat in the pre-boarding waiting area in which the passenger is sitting.

7. A method of operation where passengers holding seat assignment tickets for seats farthest from the transport vehicle entry are made to be the first to enter the transport vehicle and passengers holding seat assignment tickets closest to the transport vehicle entry are made to be the last to enter the transport vehicle.
